(19) United States
(12) Patent Application Publication
(10) Pub. No.: US 2010/0011140 A1
(43) Pub. Date: Jan. 14, 2010

(54) Ethernet Controller Using Same Host Bus Timing for All Data Object Access

(75) Inventor: Chung Chen Luan, Saratoga, CA (US)

Correspondence Address: PATENT LAW GROUP LLP, 2635 NORTH FIRST STREET, SUITE 223, SAN JOSE, CA, 95134, US

(73) Assignee: MICREL, INC., San Jose, CA (US)

(21) Appl. No.: 12/169,497

(22) Filed: Jul. 8, 2008

(51) Int. Cl. G06F 13/364; G06F 13/24

(52) U.S. Cl. 710/113; 710/260

(57) ABSTRACT

An Ethernet controller has a host interface for coupling to a host processor and a physical layer transceiver for coupling to a data network and includes multiple data objects having different access times where the data objects communicate with the host interface over an internal data bus. The Ethernet controller includes a data object interface module coupled between the host interface and the internal data bus where the data object interface module has a first access time for handling data requests for the data objects received on the host interface from the host processor, and a control logic circuit coupled to control the operation of the data object interface module. Data requests from the host processor for accessing data stored in the multiple data objects are carried out through the data object interface module using the first access time, regardless of the different access times of the multiple data objects.

### FIELD OF THE INVENTION

The invention relates to Ethernet controllers and, in particular, to an Ethernet controller allowing the host to use the same timing for all data object access.

### DESCRIPTION OF THE RELATED ART

Ethernet Controllers are incorporated in networking devices to provide network communication functions. For example, cable or satellite set-top boxes or voice over IP adapters incorporate Ethernet controllers for communicating with a data network, such as a local area network (LAN) implemented under the IEEE 802.3 standards. FIG. 1 is a representative block diagram of a conventional Ethernet controller. Referring to FIG. 1, a conventional Ethernet controller 10 includes a host interface block 16 for communicating with a host processor 12, a physical layer transceiver (PHY) 24 for communicating over the physical medium, and a host media access control (MAC) controller 26. For Fast Ethernet applications, the PHY block 24 is implemented as a 10/100 Base-T/Tx physical layer transceiver. Ethernet controller 10 also includes a buffer memory for storing the transmit and receive data. More specifically, the buffer memory is implemented as a receive queue (RXQ) 20 and a transmit queue (TXQ) 22. To allow the host processor 12 to access the receive and transmit data stored in the receive queue and the transmit queue, Ethernet controller 10 includes a direct memory access (DMA) channel 18 whereby the host processor 12 accesses the receive and transmit data through the host interface 16 and the DMA channel 18. Finally, Ethernet controller 10 includes control registers 27 and management information base (MIB) counters 28 for storing control information. An EEPROM interface block 29 may be included to support an optional external EEPROM in some applications. Registers 27-29 communicate with host interface 16 via an internal data bus 60. Finally, Ethernet controller 10 may include an LED driver 30 for driving an LED indicator where applicable.

The conventional Ethernet controller, such as Ethernet controller 10, includes various registers and memories such as RAM, FIFO, transmit queue (TXQ) and receive queue (RXQ) memories. The registers and memories are sometimes referred to collectively as “data objects” in the Ethernet controller. The timings for the host processor to access those objects are different due to different data types and internal bus architecture. Typically, the register access timing is faster than memory access timing. Among the register accesses, the timing can be different depending upon where the register resides inside the Ethernet controller. Among the memory accesses, the timing depends upon where the memory is located and what type of memory it is.

To accommodate different access timing requirements, the host processor software has to be programmed to change the timing each time the host processor needs to access a data object with access timing different from that for the last object access. To change the access timing, host processor software needs to reconfigure the host interface hardware with the correct timing for the next object access. The constant reconfiguration increases the software overhead and degrades the overall system performance.

### SUMMARY OF THE INVENTION

According to one embodiment of the present invention, an Ethernet controller has a host interface for coupling to a host processor and has a physical layer transceiver for coupling to a data network and includes multiple data objects having different access times where the data objects communicate with the host interface over an internal data bus. The Ethernet controller includes a data object interface module coupled between the host interface and the internal data bus where the data object interface module has a first access time for handling data requests for the multiple data objects received on the host interface from the host processor, and a control logic circuit coupled to control the operation of the data object interface module. In operation, data requests from the host processor for accessing data stored in the multiple data objects are carried out through the data object interface module using the first access time, regardless of the different access times of the multiple data objects.

According to another aspect of the present invention, a method of accessing data objects in an Ethernet controller is described. The Ethernet controller has a host interface for coupling to a host processor and has a physical layer transceiver for coupling to a data network and includes multiple data objects having different access times where the data objects communicate with the host interface over an internal data bus. The method includes providing a data object interface module coupled between the host interface and the internal data bus where the data object interface module has a first access time for handling data requests for the multiple data objects received on the host interface from the host processor; providing a control logic circuit coupled to control the operation of the data object interface module; and executing data requests from the host processor for accessing data stored in the multiple data objects through the data object interface module using the first access time, regardless of the different access times of the multiple data objects.

The present invention is better understood upon consideration of the detailed description below and the accompanying drawings.

### BRIEF DESCRIPTION OF THE DRAWINGS

FIG. 1 is a representative block diagram of a conventional Ethernet controller.

FIG. 2 is a block diagram of a Ethernet controller according to one embodiment of the present invention.

### DETAILED DESCRIPTION OF THE PREFERRED EMBODIMENTS

In accordance with the principles of the present invention, a uniform access time scheme for all data objects is implemented in an Ethernet controller to allow a host processor to use the same access timing to access data objects having different access time requirements. In other words, the host processor is able to access all data objects in the Ethernet controller using a uniform timing and the different types of data objects that may be present in the Ethernet controller become transparent to the host processor. In one embodiment, the uniform access time scheme for all data objects is applied to an Ethernet controller using a generic host interface bus, that is, a non-PCI interface bus. In other embodiments, the uniform access time scheme for all data objects is applied to an Ethernet controller using other types of data bus, such as a PCI (Peripheral Component Interconnect) bus. The exact nature of the host interface bus used by the Ethernet controller is not critical to the practice of the present invention.

When a uniform timing is used for all data object access in the Ethernet controller, overall system performance is improved as there is no need to reconfigure the interface hardware each time a different data object with a different access time is accessed. Furthermore, a simple and user-friendly host interface is realized as the host interface does not need to handle different access timings. System performance is greatly improved by allowing the host processor to access any data object in the Ethernet controller with the same timing regardless of the bus architecture internal to the Ethernet controller. Another benefits of uniform access time is that data stored in memories can be accessed with the faster register access timing. Traditionally, memory access speed is slower than register access speed and thus forms the key factor deciding the frame data transfer throughput and system performance. Increasing the memory access speed thereby increases the frame data transfer rate and improves system performance. Lastly, the uniform access time scheme for all data objects allows for simplified software to be implemented in the host processor and redundant overhead previously required can be removed.

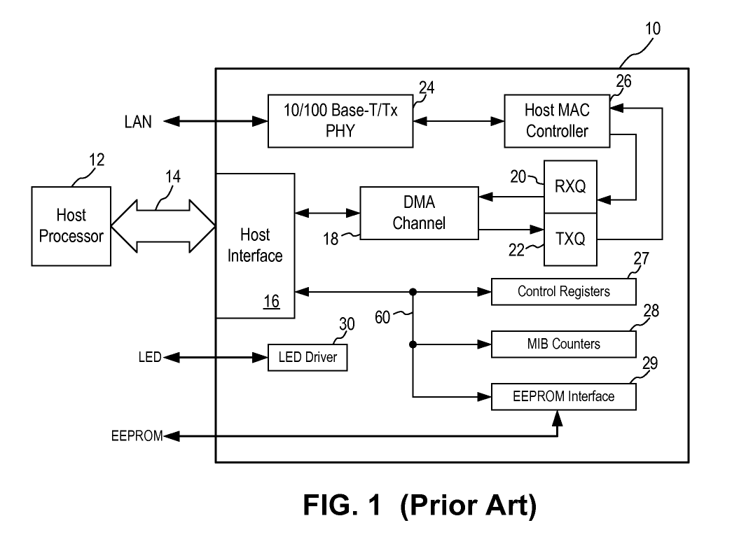

Referring back to FIG. 1, the conventional Ethernet controller 10 implements a bus architecture where the host interface 16 accesses the registers 27-29 over internal data bus 60 while accesses the RXQ 20 and TXQ 22 through an internal data bus implemented as the DMA channel 18. DMA channel 18 typically implements internal arbitration and other data bus functions. Registers 27-29 may have different access timing requirement. In order for host processor 12 to access the data stored in RXQ 20 or TXQ 22, the data requests from the host processor needs to navigate through the internal arbitration in the DMA channel 18 in order to reach the TXQ 22 and RXQ 20. Therefore, in the conventional Ethernet controller, different access timing is required for accessing the memories implementing RXQ and TXQ and the registers.

In one embodiment of the present invention, the uniform access time scheme for all data objects is implemented in the Ethernet controller using a register interface module and a memory interface module. In the present embodiment, the data objects in the Ethernet controllers are divided into two groups: registers and memories. The register interface module is situated between the host interface and the various registers in the Ethernet controller. All data requests or data writes to the registers in the Ethernet controller are routed through the register interface module. The memory interface module is situated between the host interface and all data objects in the Ethernet controller. All data requests or data writes to the memories in the Ethernet controller are routed through the memory interface module. The memory interface module and the register interface module are configured using the same access timing so that all data access to the data objects of the Ethernet controller is routed through the respective interface module and the host processor only needs to use one access timing for the register and memory interface modules to access data stored in different types of data objects.

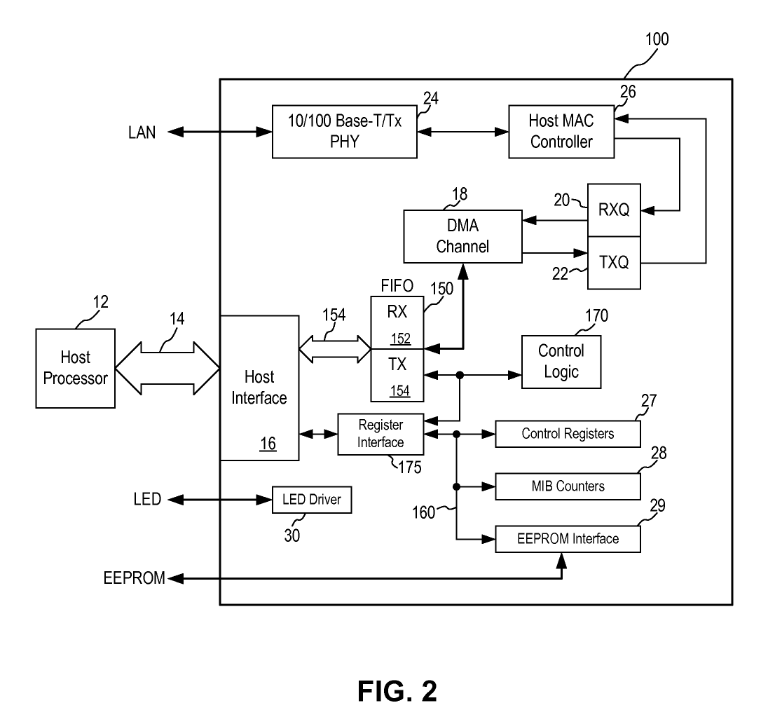

FIG. 2 is a block diagram of an Ethernet controller according to one embodiment of the present invention. Referring to FIG. 2, Ethernet controller 100 is constructed in a similar manner to Ethernet controller 10 of FIG. 1 and like elements are given like reference numerals and will not be further described in details. In brief, Ethernet controller 100 includes a physical layer transceiver (PHY) 24 for communicating over the physical medium, a host media access control (MAC) controller 26 for controlling the receipt and transmission of data, and one or more memories (20, 22) and registers (27-29) for storing data and control information.

To implement the uniform memory access time scheme, a register interface module 175 is provided to handle data accesses to all the registers (27-29) and a memory interface module 150 is provided to handle data accesses to all memories (20, 22) in Ethernet controller 100. In the present embodiment, memory interface module 150 is implemented as a First-In-First-Out (FIFO) memory.

More specifically, in accordance with the uniform memory access time scheme of the present invention, register interface module 175 is connected between the host interface 16 and the internal data bus 160 to which registers 27-29 are coupled. Register interface module 175 is controlled by a control logic block 170. Thus, register interface module 175 receives data write requests and data read requests sent by the host processor 12 on the host interface 16. Instead of requiring the host processor to handle the different access time used by the different registers, register interface module 175, under the control of control logic block 170, converts the host access requests to internal signals to derive the set of signals used for accessing any register within the Ethernet controller 100. Basically, register interface module 175 generates the internal register access signals such as read or write command, chip enable, address, and data and transmits the internal register access signals on the internal data bus. The register interface module 175 thereby simplifies the host processor register access requests and allows the same timing to be used for all register types in Ethernet controller 100.

To apply the uniform memory access time scheme of the present invention, memory interface module 150, implemented as a FIFO memory, is inserted between the host interface 16 and the DMA channel 18. FIFO 150 is controlled by control logic block 170 and operates to fetch data from or transmit data to various memory data objects within Ethernet controller 100. In the present embodiment, FIFO 150 communicates with the DMA channel 18 which forms the internal bus architecture of Ethernet controller 100. As thus configured, the host interface 16 is isolated from the DMA channel and communicates only with FIFO 150. In one embodiment, FIFO 150 is configured to use the same access timing as register interface module 175. Thus, host processor 12 uses one uniform timing to communicate with FIFO 150 and register interface module 175 for accessing all data objects in Ethernet controller 100. In essence, the host processor 12 operates to treat all read/write access to/from Ethernet controller 100 as register access which simplify the software interface and improves system performances.

In operation, when the host processor 12 needs to access data that are stored in the RXQ 20 and TXQ 22, the host processor 12 only needs to interface with FIFO 150, instead of having to go through the DMA channel 18. Thus, the faster register timing can be used to access the RXQ and TXQ memories 20, 22.

In the present embodiment, FIFO 150 includes a receive data portion (RX) 152 for storing data to be read by the host processor and a transmit data portion (TX) 154 for storing transmit data provided by the host processor. FIFO 150, operating under the control of control logic block 170, pre-loads read data for host processor 12 into RX data portion 152. In this manner, the read data is ready to be read by the host processor on the next host read RXQ request. Moreover, FIFO 150, under the control of control logic block 170, stores the transmit data for the current host write TXQ request from host processor 12 into the TX data portion 154. Thus, when the host processor 12 needs to write data to the TXQ 22, all the host processor has to do is write the data into the TX data portion 154 of FIFO 150. Then, the transmit data is written to the TXQ 22 by the interface between FIFO 150 and DMA channel 18. The internal access timing is handled by control logic block 170 and DMA channel 18. Host processor 12 no longer needs to change access timing depending on the types of data object but instead can use a uniform timing for accessing FIFO 150 and register interface module 175. The different memory types in Ethernet controller 100 become transparent to the host processor 12.

As thus configured, the host processor 12 realizes RXQ and TXQ access by directly interfacing with FIFO 150 only, bypassing the internet bus architecture of Ethernet controller 100. Thus, the faster register access timing can be used for accessing FIFO 150. Control logic block 170 manages the background activity for the previous host request and the current host request and the host requests are fully overlapped and pipelined to achieve highest hardware performance. For instance, an internal or background write inside the Ethernet controller is triggered when transmit data is written into the FIFO 150. When triggered by the writing of transmit data into TX data portion 154 of FIFO 150, control logic block 170 takes the transmit data in FIFO 150 and writes the transmit data to the TXQ 22, through the DMA channel 18. Basically, memory interface module 150 and register interface module 175, under the control of control logic block 170, generates background activities so that data is available for the CPU whenever data is to be read or to be transmitted. Register interface module 175 and memory interface module 150 operate as a timing gap between the new requests from the host and the internal activities within Ethernet controller 100.

The detail operation of the memory interface module 150 is as follows. For handling RXQ accesses from the host processor, control logic block 170 implements a pre-read mechanism to get the next read data into FIFO 150 before the next host data request. The background activity to access the next data is triggered after the read data in FIFO 150 is read by or returned to the host for the current host access request. Before the very first data is returned to host, a dummy host read cycle is required to get the first data ready into the FIFO 150 before the first actual host RXQ read request. The data from the dummy host read cycle is to be ignored by the host processor 12. After the dummy host read cycle, the first valid data is already retrieved and stored in the FIFO 150. When the host processor 12 sends the second read host RXQ read request, the data is already stored in the FIFO 150 and can be retrieved using the uniform timing.

For handling TXQ accesses from the host processor, control logic block 170 will cause the actual write data to be stored in FIFO 150. When write data is stored in FIFP 150, control logic block 170 triggers an internal background write to perform the actual write to TXQ 22. In this manner, FIFO 150 has the effect of shielding the host processor from the long TXQ access time required to actually write to the TXQ memory.

In the operation of Ethernet controller 100, there are some special register access that are issued during the execution of interrupt service routine (ISR). In operation, the values of these special registers are stored inside the RXQ and not in a register. Read operation for this type of special registers will normally trigger the register to read the value from the RXQ and update the read value into the special register. The data stored in the special registers are then returned to the host processor when the host processor issues request to this special register.

In accordance with one embodiment of the present invention, the special registers access issued during the execution of interrupt service routine (ISR) is handled using a scenario-based mechanism. In the scenario-based mechanism, a scenario is used to trigger the writing of the special register data from the RXQ to the special registers. For example, one status information that is stored in a special register is the frame length of a frame. When a frame is received, the frame length information is written into the RXQ. The frame length information is important to the host processor, particularly when the host processor is configured to read multiple frames of data at a time instead of reading one frame at a time under the conventional operation. To allow the host processor to read multiple frame, the host processor needs to retrieve the frame length information from the RXQ and then set up the link list. When the frame length information is retrieved, the host processor can then operate to read multiple frames of data from the RXQ.

In one embodiment of the present invention, a scenario, such as an Interrupt, is used to trigger the writing of the status/control information (such as frame length) from the RXQ into the respective special registers. Then, when the host processor requires the status/control information, the data is already available in the special registers and the host processor can access the information directly by reading the respective special register. In the present embodiment, the special register access goes through the register interface module 175 which ensures a uniform access time that is faster than the access time of the RXQ 20 or TXQ 22.

In accordance with another embodiment of the present invention, the special registers access issued during the execution of interrupt service routine (ISR) is handled using a bootstrapping mechanism. The bootstrapping mechanism operates by triggering a background read of the next header from the RXQ whenever the host processor reads the register storing the frame header information (register FHDRR). In normal operation, data frames stored in the RXQ is stored as a frame header followed by its corresponding frame data. The RXQ also has two RXQ read pointers. The first RXQ read pointer, referred to as “direct_read_rdptr,” is used for reading the frame header for internal hardware logic usage directly from RXQ. The other RXQ read pointer is used for host processor to read the data (header and frame) inside the RXQ. For multiple frame access, when host processor reads frame header and data, the frame header information will be discarded. The host processor uses the frame header information from direct RXQ access to create the link list for burst (multiple frames) access.

In normal operation, when RX interrupt is triggered, in the interrupt service routine (ISR), the host processor will clear the interrupt status register (ISRR). At the same time the ISRR is cleared, the number of frames to be received in this ISR visit will be captured into a received frame count register RXFCR. When the host processor reads the RXFCR, the direct_read_rdptr will be updated to point to the second frame header location in the RXQ. An internal shadow read pointer (SRPR) register carries the header information of the first frame of a number of frames to be retrieved by the host processor in this RX interrupt. The same information is also stored inside the RXQ. When host reads register RXFCR, the shadow read pointer SRPR, containing the header information of the first data frame, will be latched into a frame header read register (FHDRR). When the host processor needs the frame header information, the host processor will read the FHDRR frame header register.

At the end of the FHDRR reads, a background read will be triggered to read the next header from RXQ and update the header information to FHDRR for the host processor to read in the next host FHDRR read cycle. At the end of the next header background read, the direct_read_rdptr will be moved to the header location of next frame. By triggering the background read of the next frame header whenever the frame header register is being read, the frame header information of the next frame is pre-stored in the FHDRR for the next read cycle, thereby enabling the uniform access time scheme of the present invention.

The above detailed descriptions are provided to illustrate specific embodiments of the present invention and are not intended to be limiting. Numerous modifications and variations within the scope of the present invention are possible. The present invention is defined by the appended claims.

I claim:

1. An Ethernet controller having a host interface for coupling to a host processor and having a physical layer transceiver for coupling to a data network, the Ethernet controller including a plurality of data objects having different access times, the data objects communicating with the host interface over an internal data bus, the Ethernet controller comprising:
a data object interface module coupled between the host interface and the internal data bus, the data object interface module having a first access time for handling data requests for the plurality of data objects received on the host interface from the host processor; and
a control logic circuit coupled to control the operation of the data object interface module,
wherein data requests from the host processor for accessing data stored in the plurality of data objects are carried out through the data object interface module using the first access time, regardless of the different access times of the plurality of data objects.

2. The Ethernet controller of claim 1, wherein the plurality of data objects in the Ethernet controller comprise a buffer memory forming a receive queue (RXQ) and a transmit queue (TXQ) for storing receive data and transmit data, the buffer memory communicating with the host interface over a first internal data bus, and at least one register communicating with the host interface over a second internal data bus for storing control or status data, the buffer memory and the register having different access times.

3. The Ethernet controller of claim 2, wherein the data object interface module comprises a first data object interface module coupled between the host interface and the first internal data bus and a second data object interface module coupled between the host interface and the second internal data bus, the first and second data object interface modules having the first access time and being controlled by the control logic circuit, data requests from the host processor for accessing data stored in the buffer memory and the register are carried out through the first and second data object interface modules using the first access time.

4. The Ethernet controller of claim 3, wherein the first data object interface module comprises a first-in-first-out (FIFO) memory, the FIFO memory including a first portion for storing receive data to be read by the host processor and a second portion for storing transmit data to be transmitted onto the data network.

5. The Ethernet controller of claim 4, wherein the first data object interface module pre-loads the next read data from the RXQ of the buffer memory whenever the host interface reads data from the first portion of the FIFO memory.

6. The Ethernet controller of claim 5, wherein the host processor performs a first data request being a dummy read cycle to trigger the first data object interface module to pre-load the next read data from the RXQ of the buffer memory.

7. The Ethernet controller of claim 4, wherein the first data object interface module writes data to the TXQ of the buffer memory when the host interface writes data to the second portion of the FIFO memory.

8. The Ethernet controller of claim 3, wherein the control logic circuit is triggered by a scenario to cause data stored in the RXQ of the buffer memory to be written to the register.

9. The Ethernet controller of claim 8, wherein the scenario comprises an interrupt signal from the host processor.

10. The Ethernet controller of claim 3, wherein the control logic circuit causes the next data stored in the RXQ of the buffer memory to be written to the register whenever the host processor reads the register for the current data.

11. The Ethernet controller of claim 2, wherein the Ethernet controller comprises a plurality of registers and the second interface module communicates with the plurality of registers over the second internal data bus, the plurality of registers having different access times.

12. A method of accessing data objects in an Ethernet controller, the Ethernet controller having a host interface for coupling to a host processor and having a physical layer transceiver for coupling to a data network, the Ethernet controller including a plurality of data objects having different access times, the data objects communicating with the host interface over an internal data bus, the method comprising:
providing a data object interface module coupled between the host interface and the internal data bus, the data object interface module having a first access time for handling data requests for the plurality of data objects received on the host interface from the host processor;
providing a control logic circuit coupled to control the operation of the data object interface module; and
executing data requests from the host processor for accessing data stored in the plurality of data objects through the data object interface module using the first access time, regardless of the different access times of the plurality of data objects.

13. The method of claim 12, wherein providing a data object interface module comprises providing a first-in-first-out (FIFO) memory as the data object interface module, the FIFO memory including a first portion for storing receive data to be read by the host processor and a second portion for storing transmit data to be transmitted onto the data network.

14. The method of claim 13, further comprising:
pre-loading the next receive data into the first portion of the FIFO memory whenever the host interface reads data from the first portion of the FIFO memory.

15. The method of claim 14, further comprising:
performing a first data request being a dummy read cycle to trigger the data object interface module to pre-load the next receive data into the first portion of the FIFO memory.

16. The method of claim 13, further comprising:
writing transmit data to a first data object for transmission onto the data network when the host interface writes data to the second portion of the FIFO memory.

17. The method of claim 12, further comprising:
writing data form a first data object to a second data object when triggered by a scenario.

18. The method of claim 12, further comprising:
writing data form a first data object to a second data object whenever the host processor reads the data from the second data object.

19. The method of claim 17, wherein the scenario comprises an interrupt signal from the host processor.

20. The method of claim 17, wherein the first data object comprises a receive queue in a buffer memory and the second data object comprises a register.
